(19) United States
(12) Patent Application Publication
(10) Pub. No.: US 2019/0153762 A1
(43) Pub. Date: May 23, 2019

(54) DEVICE FOR DAMPING THE MOVEMENT OF A PIVOTABLY MOUNTED COMPONENT

(71) Applicant: ILLINOIS TOOL WORKS INC., Glenview, IL (US)

(72) Inventor: Sophia WALTER, Bad Mergentheim (DE)

(21) Appl. No.: 16/194,874

(22) Filed: Nov. 19, 2018

(30) Foreign Application Priority Data
Nov. 23, 2017 (DE) 10 2017 127 683.1

(51) Int. Cl. E05F 3/14; F16H 1/06; F16F 9/12

(52) U.S. Cl. CPC E05F 3/14; F16H 1/06; F16F 9/12; E05Y 2201/21; F16F 2222/12; F16F 2232/02; E05Y 2201/266; E05Y 2900/538

(57) ABSTRACT

A device for damping the movement of a pivotably mounted component, in particular of a flap which is mounted pivotably in a vehicle, the device including a rotation damper and a transmission element which is connectable to the component in such a manner that a pivoting movement of the component brings about a rotation of the transmission element, wherein the transmission element has a toothing at least in sections on its circumference, and wherein a toothed gearing is provided which is in engagement with the toothing of the transmission element and multiplies a rotational speed of the transmission element into a higher rotational speed of the rotation damper.

### TECHNICAL FIELD

The invention relates to a device for damping the movement of a pivotably mounted component, in particular of a flap which is mounted pivotably in a vehicle, the device comprising a rotation damper and a transmission element which is connectable to the component in such a manner that a pivoting movement of the component brings about a rotation of the transmission element.

### BACKGROUND

Devices of this type are used, for example, in vehicles, such as passenger vehicles or trucks, for damping the movement of flaps mounted in the vehicle, for example glove compartments or similar. A pivoting movement of the component brings about a rotation of the rotation damper and therefore damping of the pivoting movement. As rotation damper, use is made, for example, of dampers which have a rotor rotating in a viscous liquid. For construction space reasons, rotation dampers which are as small as possible are desired. However, in the case of small rotation dampers, direct driving of the rotation damper by the pivoting movement of the component is virtually impossible, in particular since, in the case of an arrangement close to the axis, the required torque is too large.

EP 0 846 886 B1 discloses a device for damping the movement of a pivotably mounted component, in which a rectilinear rack is coupled to a pivoting arm of the component and is in engagement with a pinion sitting on the rotor shaft of a rotation damper. With this rack gearing, transmission of the pivoting movement of the component even to small rotation dampers is easily possible. On account of the design, the device, and in particular the rotation damper, has to be arranged here at a certain distance laterally or behind the pivoting arm of the component. This increases the construction space required overall or can limit the construction space available, for example, for a glove compartment.

### SUMMARY

Starting from the prior art which has been explained, the invention is based on the object of providing a device of the type mentioned at the beginning, with which reliable damping of the pivoting movement of the component is achieved with little construction space being required.

For a device of the type mentioned at the beginning, the invention achieves the object in that the transmission element has a toothing at least in sections on its circumference, and in that a toothed gearing is provided which is in engagement with the toothing of the transmission element and multiplies a rotational speed of the transmission element into a higher rotational speed of the rotation damper.

The pivotably mounted component can be mounted pivotably in particular in the interior of a vehicle. The vehicle can be, for example, a passenger vehicle or a truck. The pivotably mounted component can be in particular a flap, for example a glove compartment flap or the like. The pivoting movement then takes place, for example, for opening and closing a space closable by the flap, such as of a glove compartment.

In the case of the device according to the invention, the transmission element has an (external) toothing at least over a section of its circumference, for example a spur toothing or a helical or conical toothing or a worm wheel toothing. The toothing of the transmission element preferably extends along a circular path on its circumference. The transmission element can be configured, for example, in the shape of a circular segment or in the shape of a piece of pie, wherein the toothing is then correspondingly formed on the circular circumferential section. Of course, the transmission element could also have an external toothing running fully over its circumference. Where gearwheels are discussed in this application, said gearwheels can in each case have an external toothing running fully or only in sections over their circumference.

According to the invention, the transmission element is in engagement by means of its toothing with a toothed gearing. The toothed gearing is coupled to the rotation damper. Said toothed gearing transmits the rotational movement of the transmission element, and therefore a pivoting movement of the component, to the rotation damper, and therefore the latter is likewise rotated. The toothed gearing brings about an increase in the rotational speed here. It is therefore a multiplication gearing. A reduction in torque takes place in a manner corresponding to the increase in rotational speed. The toothed gearing therefore ensures that the pivoting movement of the component close to the axis can be easily transmitted even to rotation dampers of a small size. At the same time, the configuration according to the invention of the rotatable transmission element with a toothing and the use of a toothed gearing lead to reduced construction space requirements in comparison to a rack gearing. In particular, it is thereby possible to arrange the device according to the invention, and in particular the rotation damper, very close to the pivoting component, for example close to the pivot axis of the component. This results overall in a more compact arrangement. By means of the rotation damper, reliable damping of the pivoting movement of the component is always realized here. With the toothed gearing according to the invention, a single-stage or multi-stage multiplication can take place.

According to a particularly practical refinement, the toothed gearing can be a spur gearing.

According to a further refinement, the toothed gearing comprises a gearwheel which is connected to the rotation damper for conjoint rotation, for example a spur gearwheel. Said gearwheel forms a pinion of the toothed gearing. It can be formed, for example integrally, on the rotation damper, in particular on a rotor of the rotation damper. The gearwheel predetermines the rotation axis of the rotation damper or of the rotor thereof.

According to a further refinement in this regard, the toothing of the gearwheel can have a smaller reference diameter than the toothing of the transmission element. The reference diameter refers in each case to the toothing. If, for example, the transmission element has such a toothing only in sections, the reference diameter correspondingly refers to this portion which is provided with the toothing, with the diameter being measured with respect to the axis of rotation of the transmission element. By means of the aforementioned refinement, a (first) multiplication of the pivoting movement of the component into a higher rotational speed of the rotation damper is achieved.

According to a further refinement in this regard, it can be provided that the toothed gearing furthermore has an intermediate gearwheel with a first toothing which is in engagement with the toothing of the transmission element and a second toothing which is in engagement with the gearwheel and is arranged coaxially with respect to the first toothing, wherein the first toothing has a smaller reference diameter than the second toothing. The intermediate gearwheel has two toothings arranged one above the other, for example spur toothings, of different diameter. The first toothing is in particular directly in engagement with the toothing of the transmission element. The second toothing is in particular directly in engagement with the gearwheel of the rotation damper. The first toothing of the intermediate gearwheel can furthermore have a smaller reference diameter than the toothing of the transmission element. Furthermore, the toothing of the gearwheel can have a smaller reference diameter than the second toothing of the intermediate gearwheel. In particular if the reference diameters of the toothings of transmission element and gearwheel of the rotation damper differ, a two-stage multiplication of the rotational speed (and therefore of the torque) of the transmission element and therefore of the component takes place together with the intermediate gearwheel. Such a two-stage multiplication reduces the forces to be transmitted during the respective multiplication, and therefore the required transmission ratio can also easily be realized, for example, when plastics components, which can be produced cost-effectively and simply, are used for the gearing.

The transmission element, the toothed gearing and the rotation damper can be arranged in a common housing of the device. This results in a particularly compact constructional form and simple installation. The housing with all of the components of the device according to the invention can then be positioned directly in the vicinity of the pivot axis of the component, with the drive of the rotation damper taking place, for example, by means of a pivot arm of the component.

The rotation damper can have a rotor which is rotatable in a damper portion of the housing, said damper portion being filled with a viscous liquid. The rotor is rotatable in relation to the stationary housing, for example via the gearwheel connected to the rotation damper for conjoint rotation. The rotor rotates here in a damper section of the housing that is filled with a viscous liquid, for example an oil. This results in a braking action which, in turn, produces the desired damping during the pivoting of the component.

According to a further refinement, the transmission element can have a latching portion with which said transmission element can be latched to the component. By means of such a latching connection, particularly simple installation and optionally also removal are possible. The latching portion can comprise, for example, one or more latching projections and/or latching receptacles which interact in a latching manner with corresponding latching receptacles or latching projections of the component.

The latching portion can be formed on a guide projection which projects out of the housing and is guided in a guide groove of the housing during pivoting of the component. As already mentioned, the housing is arranged in a stationary manner, for example is fastened to a body portion or paneling portion of a vehicle. When the component pivots, the transmission element is rotated in the housing, with a rotation, multiplied via the toothed gearing, of the rotor of the rotation damper in the damper portion, which is filled with the viscous liquid, of the housing. In this refinement, the latching portion of the transmission element is designed for connection to the component at a guide projection protruding out of the housing. The housing has a guide groove which runs, for example, along a circular portion and in which the guide projection is guided during the described rotation of the transmission element in the housing. As a result, reliable and simple guiding takes place.

According to a further refinement, the transmission ratio of the toothed gearing can be at least 1:15, preferably at least 1:18. For example, a rotational speed of the component and therefore of the transmission element of 3 rpm into a rotational speed of 45 rpm of the rotation damper could take place. Correspondingly, a torque would be reduced from, for example, 2 Nm to approximately 0.13 Nm.

The rotation damper can be a rotation damper with freewheeling in one direction of rotation. Such freewheeling rotation dampers are known per se. They deploy their damping effect only in one direction of rotation which can correspond, for example, to the opening movement of a flap arranged in a vehicle. By contrast, substantially no damping takes place in the opposite direction of rotation. It is also possible for the device to comprise a freewheeling device which is separate from the rotation damper and brings about the freewheeling of the rotation damper.

According to a further refinement, at least the transmission element and the toothed gearing can be composed of a plastic. The housing can also be composed of a plastic. The rotation damper can also be composed of a plastic. This results overall in cost-effective and simple production, for example in a plastics injection molding process. Of course, however, other materials are also conceivable for some or all of the components of the device according to the invention.

The invention also relates to a system consisting of a pivotably mounted component, preferably a flap mounted pivotably on a vehicle, and a device according to the invention, wherein the component is connected to the transmission element of the device. As already explained, the vehicle can be, for example, a passenger vehicle or truck. The flap can be, for example, a glove compartment flap or similar.

### BRIEF DESCRIPTION OF THE DRAWINGS

An exemplary embodiment of the invention is explained in more detail below with reference to figures, in which, schematically:

FIG. 1 shows a device according to the invention in a perspective view,

FIG. 2 shows the device from FIG. 1 in a perspective exploded illustration,

FIG. 3 shows the device from FIG. 1 in a partially sectioned perspective illustration in a first operating state,

FIG. 4 shows the illustration from FIG. 3 in a second operating state,

FIG. 5 shows a perspective view of a system according to the invention in a first operating state, and

FIG. 6 shows the view from FIG. 5 in a second operating state.

Unless stated otherwise, the same reference signs denote identical objects in the figures.

### DETAILED DESCRIPTION

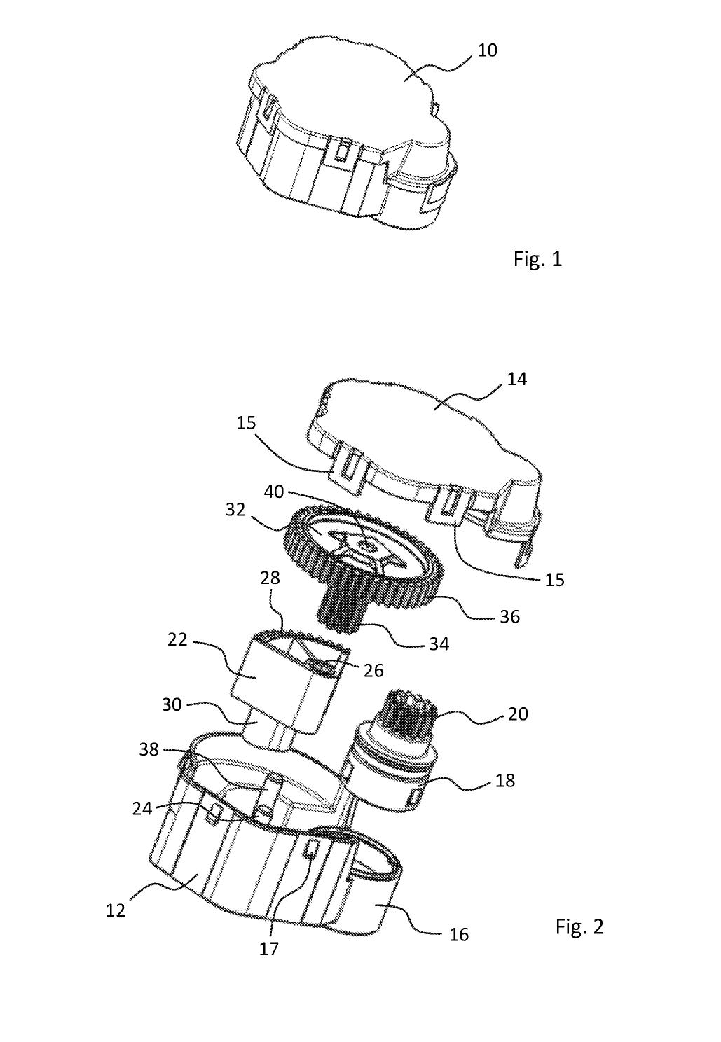

A housing 10 of the device according to the invention can be seen in FIG. 1. In the example shown, the housing 10 is composed of a plastics material. As can be seen in particular in FIG. 2, the housing 10 comprises a basic body 12 and a housing cover 14. The basic body 12 has a cup-shaped damper portion 16 which, in the mounted state, is filled with a viscous liquid, for example an oil. In the mounted state, a rotor 18 of a rotation damper is arranged rotatably in the damper portion 16. At an end facing away from the rotor, the rotation damper also has a spur gear 20 which, in the example shown, is formed integrally on the rotation damper. The axis of rotation of the spur gear 20 at the same time forms the axis of rotation of the rotor 18. The rotation damper can be formed integrally overall. However, it can also be constructed from a plurality of components, in particular if it is a rotation damper with freewheeling in one direction of rotation. Such rotation dampers with freewheeling are known per se and will not be explained in more detail here. The rotation damper can likewise be composed of a plastic. In addition, latches 15 of the housing cover 14, with which the housing cover 14 latches to corresponding latching projections 17 of the basic body 12 or damper portion 16 for simple installation can be seen in FIG. 2.

The device also comprises a transmission element 22 which is mounted rotatably in the basic body 12 of the housing. For this purpose, a first rotary shaft 24 is arranged in the basic body 12 and is received in a shaft receptacle 26 of the transmission element 22. The transmission element 22 also has a spur toothing 28 in sections on its circumference. As can be seen in particular in FIG. 2, the transmission element 22 is in the shape of a piece of pie. Furthermore, in FIG. 2, a guide projection 30 is formed on the lower side of the transmission element 22 and serves for connection to a pivotably mounted component, in particular a flap mounted pivotably on a vehicle. The guide projection 30 is arranged eccentrically with respect to the axis of rotation of the transmission element 22, the axis of rotation being defined by the shaft receptacle 26. Furthermore, the device comprises an intermediate gearwheel 32 with a first toothing 34, in particular spur toothing 34, and a second toothing 36 arranged coaxially with respect to the first toothing 34, in particular spur toothing 36. A second rotary shaft 38 is arranged in the basic body 12 of the housing 10 and, in the mounted state, is received in a rotary receptacle 40 of the intermediate gearwheel 32. The intermediate gearwheel 32 is thereby mounted in the basic body 12 of the housing 10 so as to be rotatable about the second rotary shaft 38. In the mounted state, the first toothing 34 of the intermediate gearwheel 32 is in engagement with the spur toothing 28 of the transmission element 22. In the mounted state, the second toothing 36 of the intermediate gearwheel 32 is in engagement with the spur gearwheel 20 of the rotation damper. It can also be seen in particular in FIG. 2 that the toothing of the spur gearwheel 20 has a smaller reference diameter than the spur toothing 28 of the transmission element 22. In addition, it can be seen that the first toothing 34 of the intermediate gearwheel 32 has a smaller reference diameter than the second toothing 36. A two-stage multiplication of a rotational speed during a rotational movement of the transmission element 22 into a higher rotational speed of the spur gearwheel 20, and therefore of the rotation damper, thereby takes place, with a corresponding reduction in torque. As explained at the beginning, the transmission ratio can be, for example, at least 1:15, preferably at least 1:18. The transmission element 22 and the intermediate gearwheel 32 can also be composed of plastic.

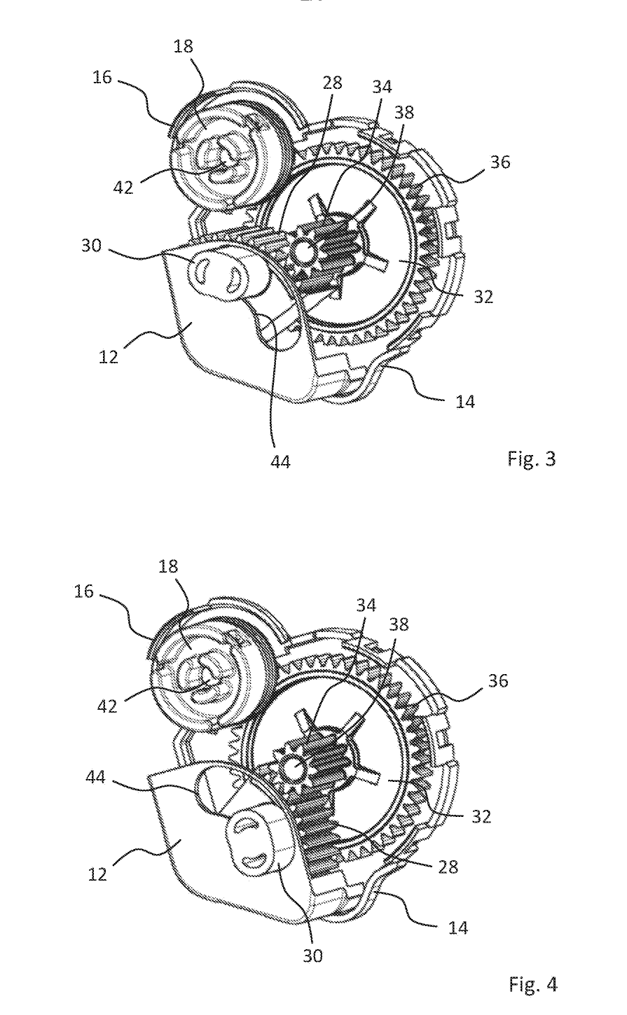

The lower side (concealed in FIGS. 1 and 2) of the basic body 12 of the housing 10 is shown in FIGS. 3 and 4. For illustrative reasons, parts of the housing 10 have been cut away here. It can also be seen here that a third rotary shaft 42 is arranged in the damper portion 16, which is filled with the viscous liquid during operation, said rotary shaft being received in a corresponding rotary shaft receptacle of the rotor 18 of the rotation damper. The rotatable mounting of the rotation damper and in particular of the rotor 18 thereof in the damper portion 16 takes place in this manner.

On account of the eccentric arrangement of the guide projection 30 with respect to the axis of rotation, which is defined by the first rotary shaft 24, of the transmission element 22, a pivoting movement of the component connected to the guide projection 30, for example via a latching connection, for example of a pivot arm of the component, leads to rotation of the transmission element 22 about the first rotary shaft 24, wherein the guide projection 30 protruding from the basic body 12 of the housing 10 is guided in a guide groove 44 running along a section of a circular path. The rotational movement of the transmission element 22 can readily be seen with reference to a comparison of FIGS. 3 and 4. For example, FIG. 3 can correspond to a closed state of the component, for example of a flap, and FIG. 4 to an open state of the component, for example of a flap. The rotational movement of the transmission element 22 is transmitted via the intermediate gearwheel 32 and the spur gearwheel 20 into a rotational movement of the rotor 18 in the viscous liquid in the damper portion 16 with greater rotational speed and lower torque. The rotation of the rotor 18 in the viscous liquid leads to a braking action which, in turn, brings about a corresponding damping of the pivoting movement of the component.

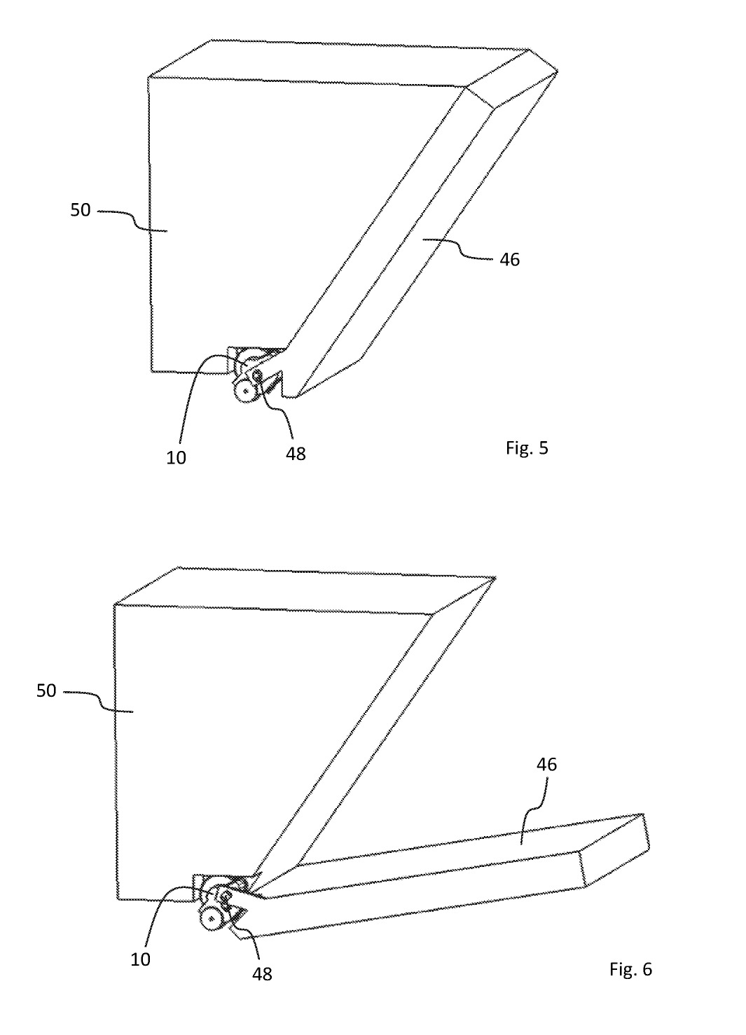

On account of its compact construction, the device according to the invention, in particular the housing 10, can be fastened in the direct vicinity of the component, in particular of a pivot axis of the component, in a stationary manner to a carrier component of the vehicle, for example a body part or paneling part. The construction space taken up is minimized. This can be seen in FIGS. 5 and 6 where a component 46, here a flap 46, is shown in a closed state (FIG. 5) and an open state (FIG. 6). The pivot axis of the flap 46 is shown at the reference sign 48. It can be seen in FIGS. 5 and 6 that the device according to the invention is arranged with its housing 10 directly in the region of the pivot axis 48. At reference sign 50, a compartment can also be seen, here a glove compartment 50 of a vehicle, which compartment can either be closed or opened by the flap 46.

Features of the invention include features A-O as follows:

A. A device for damping the movement of a pivotably mounted component (46), in particular of a flap (46) which is mounted pivotably in a vehicle, the device comprising a rotation damper and a transmission element (22) which is connectable to the component (46) in such a manner that a pivoting movement of the component (46) brings about a rotation of the transmission element (22), wherein the transmission element (22) has a toothing (28) at least in sections on its circumference, and wherein a toothed gearing is provided which is in engagement with the toothing (28) of the transmission element (22) and multiplies a rotational speed of the transmission element (22) into a higher rotational speed of the rotation damper.

B. The device of A, wherein the toothed gearing is a spur gearing.

C. The device of A or B, wherein the toothed gearing comprises a gear wheel (20) which is connected to the rotation damper for conjoint rotation.

D. The device of C, wherein the toothing of the gear wheel (20) has a smaller reference diameter than the toothing (28) of the transmission element (22).

E. The device of C or D, wherein the toothed gearing furthermore has an intermediate gear wheel (32) with a first toothing (34) which is in engagement with the toothing (28) of the transmission element (22) and a second toothing (36) which is in engagement with the gear wheel (20) and is arranged coaxially with respect to the first toothing (34), wherein the first toothing (34) has a smaller reference diameter than the second toothing (36).

F. The device of E, wherein the first toothing (34) of the intermediate gear wheel (32) has a smaller reference diameter than the toothing (28) of the transmission element (22).

G. The device E or F, wherein the toothing of the gear wheel (20) has a smaller reference diameter than the second toothing (36) of the intermediate gear wheel (32).

H. The device of any of A-G, wherein the transmission element (22), the toothed gearing and the rotation damper are arranged in a common housing (10) of the device.

I. The device of H, wherein the rotation damper has a rotor (18) which is rotatable in a damper portion (16) of the housing (10), said damper portion (16) being filled with a viscous liquid.

J. The device of any of I-J, wherein the transmission element (22) has a latching portion with which said transmission element can be latched to the component.

K. The device of J and either of H or I, wherein the latching portion is formed on a guide projection (30) which projects out of the housing (10) and is guided in a guide groove (44) of the housing (10) during pivoting of the component.

L. The device of any of A-K, wherein the transmission ratio of the toothed gearing is at least 1:15, preferably at least 1:18.

M. The device of any of A-L, wherein the rotation damper is a rotation damper with freewheeling in one direction of rotation.

N. The device of any of A-M, wherein at least the transmission element (22) and the toothed gearing are composed of a plastic.

O. A system consisting of a pivotably mounted component (46), preferably a flap (46) mounted pivotably in a vehicle, and the device of any of A-N, wherein the component (46) is connected to the transmission element (22) of the device.

### LIST OF REFERENCE SIGNS

10 Housing
12 Basic body
14 Housing cover
16 Damper portion
18 Rotor
20 Spur gearwheel
22 Transmission element
24 First rotary shaft
26 Shaft receptacle
28 Spur toothing
30 Guide projection
32 Intermediate gearwheel
34 First toothing
36 Second toothing
38 Second rotary shaft
40 Rotary receptacle
42 Third rotary shaft
44 Guide groove
46 Component
48 Pivot axis
50 Compartment

What is claimed is:

1. A device for damping the movement of a pivotably mounted component, the device comprising a rotation damper and a transmission element which is connectable to the component in such a manner that a pivoting movement of the component brings about a rotation of the transmission element, wherein the transmission element has a toothing at least in sections on its circumference, and wherein a toothed gearing is provided which is in engagement with the toothing of the transmission element and multiplies a rotational speed of the transmission element into a higher rotational speed of the rotation damper.

2. The device as claimed in claim 1, wherein the toothed gearing is a spur gearing.

3. The device as claimed in claim 1, wherein the toothed gearing comprises a gear wheel which is connected to the rotation damper for conjoint rotation.

4. The device as claimed in claim 3, wherein the toothing of the gear wheel has a smaller reference diameter than the toothing of the transmission element.

5. The device as claimed in claim 4, wherein the toothed gearing furthermore has an intermediate gear wheel with a first toothing which is in engagement with the toothing of the transmission element and a second toothing which is in engagement with the gear wheel and is arranged coaxially with respect to the first toothing, wherein the first toothing has a smaller reference diameter than the second toothing.

6. The device as claimed in claim 5, wherein the first toothing of the intermediate gear wheel has a smaller reference diameter than the toothing of the transmission element.

7. The device as claimed in claim 6, wherein the toothing of the gear wheel has a smaller reference diameter than the second toothing of the intermediate gear wheel.

8. The device as claimed in claim 1, wherein the transmission element, the toothed gearing and the rotation damper are arranged in a common housing of the device.

9. The device as claimed in claim 8, wherein the rotation damper has a rotor which is rotatable in a damper portion of the housing, said damper portion being filled with a viscous liquid.

10. The device as claimed in claim 9, wherein the transmission element has a latching portion with which said transmission element can be latched to the component.

11. The device as claimed in claim 10, wherein the latching portion is formed on a guide projection which projects out of the housing and is guided in a guide groove of the housing during pivoting of the component.

12. The device as claimed in claim 1, wherein the transmission ratio of the toothed gearing is at least 1:15, preferably at least 1:18.

13. The device as claimed in claim 1, wherein the rotation damper is a rotation damper with freewheeling in one direction of rotation.

14. The device as claimed in claim 1, wherein at least the transmission element and the toothed gearing are composed of a plastic.

15. A system consisting of a pivotably mounted component and a device as claimed in claim 1, wherein the component is connected to the transmission element of the device.

16. A device for damping the movement of a flap that pivotably mounted in a vehicle, the device comprising a rotation damper and a transmission element which is connectable to the flap such that a pivoting movement of the flap brings about a rotation of the transmission element, wherein the transmission element has a toothing at least in sections on a periphery of the transmission element, and wherein a toothed gearing is provided which is in engagement with the toothing of the transmission element and multiplies a rotational speed of the transmission element into a higher rotational speed of the rotation damper.

17. The device as claimed in claim 16, wherein the toothed gearing is a spur gearing.

18. The device as claimed in claim 16, wherein the toothed gearing comprises a gear wheel which is connected to the rotation damper for conjoint rotation.

19. The device as claimed in claim 18, wherein the toothing of the gear wheel has a smaller reference diameter than the toothing of the transmission element.

20. The device as claimed in claim 19, wherein the toothed gearing furthermore has an intermediate gear wheel with a first toothing engaged with the toothing of the transmission element and a second toothing engaged with the gear wheel and is arranged coaxially with respect to the first toothing, wherein the first toothing has a smaller reference diameter than the second toothing.
